(19) United States
(12) Patent Application Publication
(10) Pub. No.: US 2006/0152034 A1
(43) Pub. Date: Jul. 13, 2006

(54) Mounting system for convertible-roof liner

(75) Inventor: Heinz Schonenbach, Remscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: PARAT AUTOMOTIVE SCHONENBACH GMBH + CO. KG

(21) Appl. No.: 11/238,679

(22) Filed: Sep. 29, 2005

(30) Foreign Application Priority Data
Sep. 29, 2004 (DE) 102004047910.0

(51) Int. Cl. B60J 7/12

(52) U.S. Cl. 296/107.12

(57) ABSTRACT

A device for stretching or positioning at least one roof panel (13), in particular of a motor-vehicle convertible roof, relative to at least one link element with at least one traction element (11a, 11b, 37), in particular a cable, for connection to the link element (29) and/or to a roof panel (13) and that for this purpose at least one end one connector (31, 51) that cooperates with another connector (12a, 12b, 13c, 50) that is directly or indirectly fixed on the roof panel (13) or on the link element (20). It is an object of the invention to provide a device for stretching or positioning roof panels where it is simple to mount the traction element on the roof panel.

This object is attained in that the one connector (31, 51) and the other connector (12a, 12b, 12c, 50) are releasably connected together.

The invention relates to a device for stretching or positioning at least one roof panel according to the introductory clause of claim 1.

Roof frames, for example for motor-vehicle convertible roof, can be comprised of a number of link elements, as for example one- or two-arm levers or knee levers. They are interconnected by flat link elements and facilitate the opening and closing movement of the convertible roof. As a result of the relatively large travel of the link elements it is however difficult to mount roof panels, for example the roof liner of a motor-vehicle roof, on them. Relatively large relative movements take place near the vehicle frame C-column where the stretching bars for the cover and their knee levers are provided. For this reason devices are provided with cables that are secured to the link elements and the roof panels.

Such a device is known from applicant's German patent 4,031,279. A traction cable is connected at one end to a link element, passes through deflecting eyes on the stretching bars and on a bow and is attached at its other end solidly to the roof panel. Another cable is connected at one end with the roof panel, passes through deflector eyes on a link element and on the bow, and is fixed at its other end to the roof panel.

Securing the roof panel has been done by the applicant by for example directly riveting it or securing it to a link element. In the latter case the traction cable is riveted to the link element or the end of the traction cable is passed through a hole in the link element and swaged to a stop fitting so that it cannot pass back through the passage. This permanent mounting of a stop fitting must be done during the assembly and makes mounting the cable very expensive.

If the cable must be subsequently separated from the roof panel, its swaged end must be cut off, which makes the cable unusable.

It is an object of the invention to improve on the above-described system and provide a device for stretching or positioning at least one roof panel that makes mounting the device easier.

The invention attains this object with the features of claim 1, in particular the features of the characterizing clause, in that the one connector and the other connector are releasably connected together.

The principle of the invention is therefore mainly that one or both ends of the traction element is provided with one connector that when assembled is connected with another connector fixed to the roof panel and that the connection can be undone and remade.

A roof panel in accordance with the invention is for example a portion of the liner of a motor-vehicle roof, it being irrelevant what material the vehicle roof is made of externally. Alternatively the roof panel can be the outer layer of a motor-vehicle or of another cover or another panel that is tensioned or positioned by link elements.

The traction element is according to the invention secured to at least one link element and/or to the roof panel. This means on the one hand that the traction element is secured at one end to the link element and at the other end to the roof panel. Alternatively the traction element is secured at both ends to the roof panel. The traction element can be held for example between is its two ends be means of deflecting eyes on at least one link element or on the roof panel.

The traction element according to the invention has a connector at at least one end that is fixed on the traction element. It is thus possible that one connector is fixed at an end of the traction element or that the traction-element end itself forms the cone connector. In the latter case a thickened region of the traction element or a knot forms the one connector. The connector can be formed simply by the end of the traction element when for example the other connector is formed as a gripper. The one connector is thus preferably a separate part that is fixed on the end of the traction element. Alternatively however the end of the traction element can itself form the one connector. It is noted that there can be several traction elements.

The device according to the invention has the substantial advantage that now the traction element can not only be very easily secured to the roof panel or to the link element but also can in a simple manner subsequently be disconnected and then reconnected. Such disconnection and reconnection can be advantageous with a motor-vehicle roof in order to make a correction possible when the traction element gets out of position on the link element. In addition it is possible to completely remove the roof liner. During final assembly the roof liner according to the invention can be put in place, and the roof liner can be partly dismounted and then reinstalled.

The device according to the invention ensures a solid connection between the one connector and the other connector to transmit traction from the link element to the roof panel. In addition the individual parts of the device are very simple to manufacture and can be preassembled by machines, which is not the case with the prior art.

According to an embodiment of the invention the one connector and the other connector are fitted into each other. This connection can be such that the one connector is fitted in a mounted position with the other connector and can if necessary be taken out of this position, possibly with the aid of a tool. Such a plug-type connection has the advantage of easy connection and reconnection but does not get disconnected inadvertently.

According to a further embodiment of the invention the one connector is an anchor element and the other connector has an abutment. With such a connection the anchor faces lie against the abutment faces. Such an interaction of anchor element and abutment forms a solid connection between the traction element and the roof panel. The anchor element can here be for example an element that is pressed onto the end of the traction element. Even a thickening of the end of the traction element can be the anchor element. The abutment can be for example a wall region of the other connector or something that grips the end of the traction element. In addition the connection is simple to make up and disconnect.

According to a further embodiment of the invention the other connector has at least one tunnel- or window-like passage through which extends an end of the traction element or the one connector. This embodiment implements the abutment function in a particularly simple manner in the other connector. The assembly can also be done very easily in that the anchor element at a predetermined orientation or in a predetermined assembled condition is fitted through the tunnel- or window-like passage in the other connector and then made to bear on the wall face of the other connector.

In accordance with a further embodiment of the invention the passage has a diameter, and a length of the one connector is greater than the diameter. The passage can be circular so that it only has a diameter. If the passage is rectangular or has another shape, the length of the stop fitting can be greater than the largest crosswise dimension of the passage. In this case the stop fitting can only be separated from the other connector when its longitudinal axis is oriented parallel to the longitudinal axis of the passage. Alternatively it is also possible that the length of the stop fitting is bigger than one crosswise dimension but not of the largest crosswise dimension. For connection the stop fitting is then laid against a region of the other connector where the crosswise dimension of the passage is smaller than the length of the stop fitting.

According to a further embodiment of the invention wall faces of the other connector turned toward the one connector and adjacent the passage form the abutment. The abutment can thus be made very simply.

According to a further embodiment of the invention the one connector is formed by a stop fitting fixed on the traction element. Such a stop fitting, for example made of a metal like aluminum, can be swaged solidly into the traction element and forms a very inexpensive type of connector.

According to a further embodiment of the invention a longitudinal axis of the stop fitting is generally perpendicular to a longitudinal axis of the traction element. In this manner abutment faces are formed by the stop fitting that are complementary to abutment faces of the other connector. If the traction element is laid against the side of the stop fitting for mounting the one connector, recoil forces naturally reorient the stop fitting after assembly so that it extends perpendicular to the longitudinal axis of the traction element.

In accordance with a further embodiment of the invention the other connector has at least a first region for securing the one connector and a second region for securing to the roof panel or to the link element. Securing the other connector on the roof panel can thus be done directly or indirectly.

In accordance with a further embodiment of the invention the second region of the other connector is formed by a plate-shaped element or a bar element. With such a plate-shaped or bar element mounting the other connector on the roof panel is easy by gluing, sewing, or laminating. There are other possibilities. The mounting region can be a flexible part that can be stitched to the roof panel.

According to a further embodiment of the invention the first region of the other connector is unitarily formed with the second region. The two regions can be integrally glued together or formed as one molded piece. This embodiment of the invention makes it easy to manufacture the other connector.

In accordance with a further embodiment of the invention the other connector is formed of at least two regions, the first region being separable from the second region. This embodiment makes it possible to fix one part of the other connector first on the traction element and the other part on the roof panel and then to join the two regions together. Disconnection by separating the connection is possible with no problem.

According to a further embodiment of the invention a latch nose is provided on the one region that engages complementarily in a recess of the other region. This embodiment of the invention ensures the advantage of simplified construction and simple disconnection and reconnection.

A further embodiment of the invention provides that at least two other connectors are connected with each other. Several other conductors can be made cheaply of a single molded part. They can for example be connected together on a strip. The roof panel and several connectors can be fixed to the strip. It is also possible for example to secure connectors of different traction elements on the strip.

In according to with a further embodiment of the invention the other connector is provided with a wedge seat for deflecting the traction element. Independently of how the connection is made between the one connector and the other connector, with this embodiment the traction element is deflected in the direction of the load and held in this position. This embodiment of the invention has the additional advantage that the one connector is held by the wedging action of the traction element on the abutment of the other connector.

According to a further embodiment of the invention the wedge seat has a V-shaped diverging opening region. With this embodiment the traction element can be easily mounted in the wedge seat in that after connecting to the other connector it is passed over the V-shaped diverging opening into the wedge seat. The passage can have offset from the seat a narrow region through which the traction element can be forced so that it does not get loose by accident.

Further advantages of the invention are seen in the uncited dependent claims and with reference to the embodiment described with reference to the drawing. Therein:

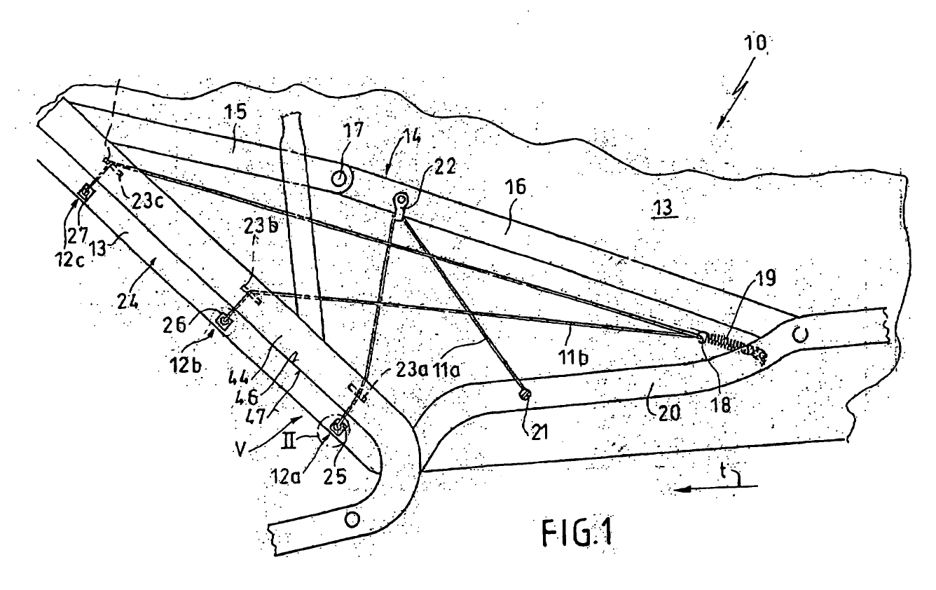

FIG. 1 is partial schematic view of a closed or tensioned convertible roof;

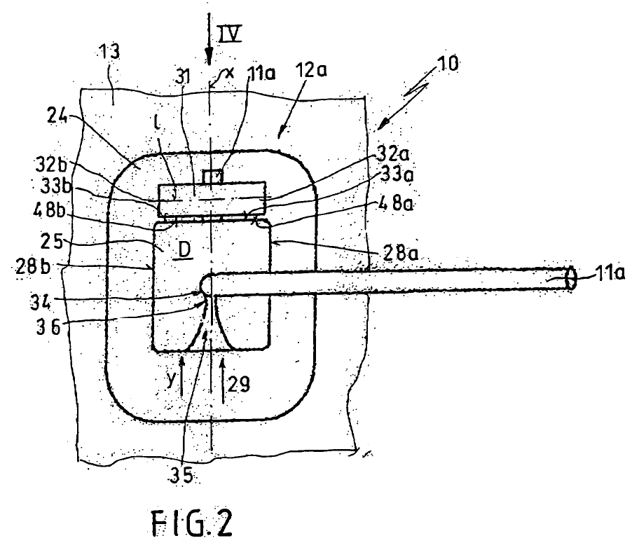

FIG. 2 is a top large-scale view of a first embodiment of the device according to the invention according to circle II of FIG. 1;

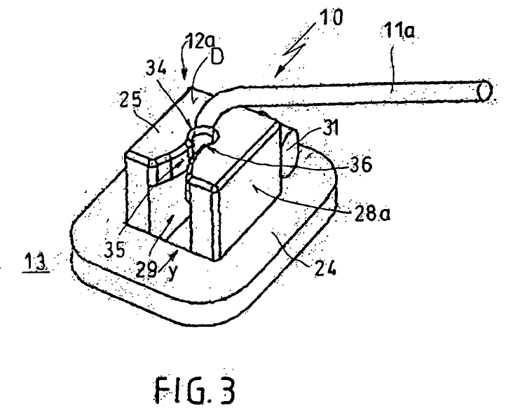

FIG. 3 is a perspective view of the structure of FIG. 2;

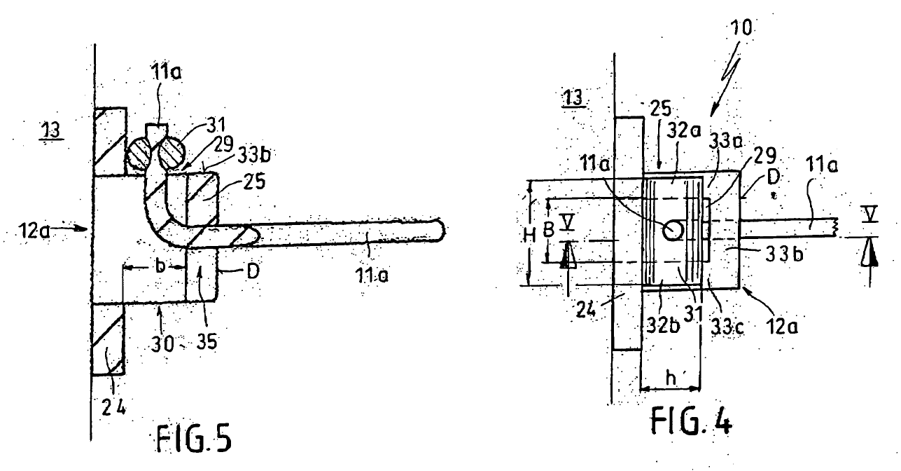

FIG. 4 is a view taken in the direction of arrow IV of FIG. 2;

FIG. 5 is a partly sectional view of the structure according to section line V-V of FIG. 4.

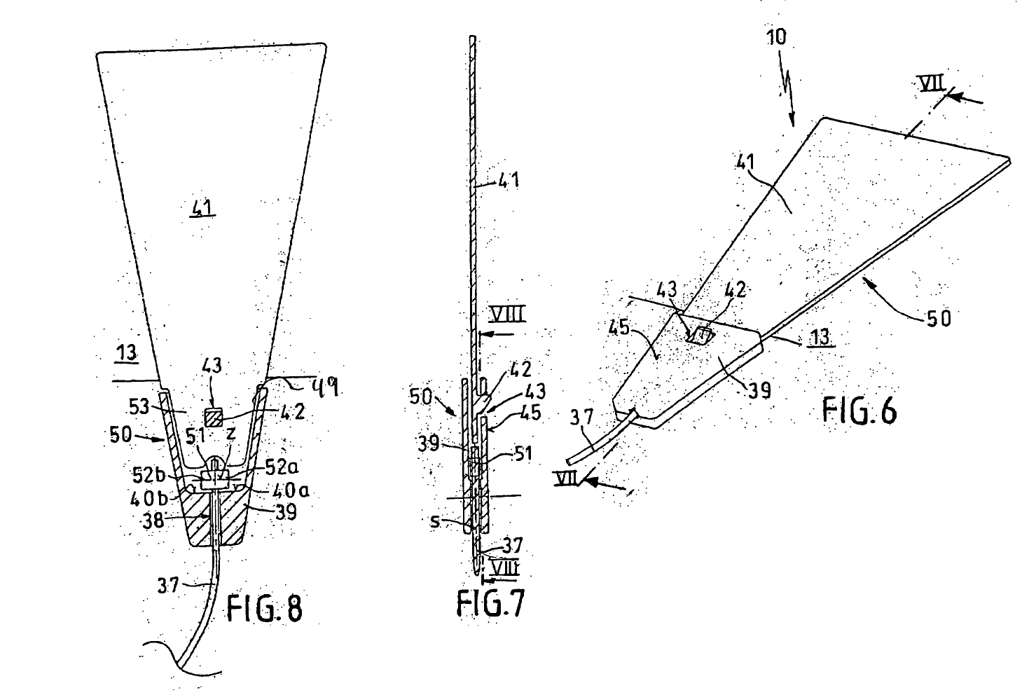

FIG. 6 is a perspective view seen at an angle of a further embodiment of the device;

FIG. 7 is a section of the device according to line VII-VII of FIG. 6; and

FIG. 8 is a section of the device according to line VIII-VIII of FIG. 7.

The drawing shows a device for tensioning and positioning a roof element shown generally at 10. The same references with small letters are used in the various figures for the same parts.

FIG. 1 shows the device as part of a roof as used for example on a convertible. FIG. 1 shows relative to a vehicle travel direction t the left side of the roof near the vehicle-body C-column. The convertible roof has a link assembly V above a roof liner 13. The outer layer of the roof is not shown. The roof link assembly V has a knee-lever subassembly 14 that has two knee levers 15 and 16 that are pivoted together at 17. The knee lever 16 is pivoted on a tensioning bow 20 while the knee lever 15 is pivoted on a folding spreader 44.

As a result of the considerable range during opening of the roof by the link elements, for example the knee-lever subassembly 14, the roof liner 13 cannot be directly fixed to the link assembly V. In order to make it possible to stretch the liner traction cords 11a and 11b are provided that are connected via the link assembly with the liner 13. Instead of textile traction cords 11a and 11b it is possible to use cords of plastic, metal, or further materials. The traction cord 11a is secured at one end by a screw connector 21 to the bow 20, passes through a deflecting eye 22 on the knee lever 16, and is connected with its other end in a manner to be described below with another connector 12a. The other connector 12a is part of a molded plastic part formed by a bar element 24 that is formed in addition to the connector 12a with other connectors 12b and 12c and which is laminated to the roof liner 13. The other connectors 12a, 12b, and 12c have caps 25, 26, and 27 whose construction is described more closely below.

The traction cord 11b is guided through a deflector eye 18 of a spring 19 and through further deflecting eyes 23b and 23c that are provided on the spreader 44 and is fixed at its ends to the other connectors 12b and 12c. The spring 18 is for its part mounted on the bow 20 forming part of the link assembly V.

In FIG. 1 the roof is in its up position. The lengths of the cords 11a and 11b are such that they press the bar 24 with the liner 13 secured to it against the bow leg 44. The liner 13 is for example glued to the bar 24. An edge 46 of the bar 24 bears in the up position of the mechanism V on an edge 47 of the bow 44.

The connection of the end of the cord 11a to the other connector 12a is shown by way of example in FIGS. 2 to 5. Here it is clear that the connector 12a has the cap 25. The cord 11b according to FIG. 1 is secured at one end to the other connector 12b and with the opposite end to the connector 12c. The other connectors 12b and 12c are also provided with caps 26 and 27. The cord 11b is mounted in the same manner to both connectors 12b and 12c as described below, which is identical to the mounting of the cord 11a to the cap 25.

FIGS. 2 to 5 show in detail the connector 12a separate from the bar 24 that is formed as shown in FIG. 1 with all of the connectors 12a, 12b, and 12c. Contrary to FIGS. 2 to 5, it is also possible that the connector 12a can not be a separate but, but instead be unitary with the bar 24. The connector 12a can also be a separate part. The cap 25 has as shown in FIG. 2 opposite walls 28a and 28b and a top wall D. The walls 28a, 28b, and D form a passage 29 as best shown in FIG. 5. The cord 11a is provided with a crimped-on connector constituted as a metallic, e.g. aluminum, stop fitting 31. The swaging or crimping is carried out during manufacture before the cords 11a and 11b are mounted on the linkage V or on the liner 13. A length H of the fitting 31 in the direction of its longitudinal axis 1 (see FIG. 2) is substantially greater than its diameter h perpendicular thereto. A height b and a width B of the passage 29 (see FIGS. 4 and 5) are such that the fitting 31 can only fit through the passage 21 when its axis 1 is aligned with an axis x (FIG. 2) of the passage 29. The length H of the fitting 31 is thus larger than the width B or the height b of the passage 29. The traction cord 11a is secured as follows to the other connector 12a:

For mounting the traction cord 11a to the connector 12a the axis 1 of the fitting 31 is aligned parallel to the axis x and the fitting 31 is pushed through the passage 29 in direction y by means of an unillustrated tool pin. Once the fitting 31 has passed out of the end of the passage 29, natural elasticity orients it transversely of the cord 11a so that it lies across the mouth of the passage 29, bearing with faces 48a and 48b of its ends 32a and 32b on faces 33a, 33b, and 33c of the cap 25.

With the longitudinal axis 1 aligned perpendicular to the 25 axis x, the fitting 31 cannot pass through the passage 29 (see FIG. 4) since the length H of the fitting 31 is greater than both the width B and height b of the passage 29. Since the longitudinal axis 1 of the fitting is not likely to orient itself parallel to the axis x due to the natural elasticity of the cord 11a, there is no significant danger that the fitting 31 will pass through the passage 29. In addition the passage 29 is dimensioned such that the fitting 31 can only be forced through it by a tool. The system 10 therefore is ensured to have a solid connection between the liner 13 and the linkage V.

In order further to prevent unintended disconnection of the cord 11a from the cap 25 and also the route the cord 11a in the direction of its load, a seat 34 is provided with V-shaped diverging flanks 35 on the cap 25 (see FIG. 2). The flanks 35 have adjacent the seat 34 a restriction 36 so that the cord 11a must be forced past the restriction 36 into the seat or radially out of it. In this manner the cord 11a cannot pull unintentionally out of the seat 34. In addition the flanks 32 of the fitting 31 are also held against the faces 33a, 33b, and 33c of the connector 12a (see FIG. 4) so that it is always retained in place.

To disassemble the device 10 the end of the cord 11a is first pulled radially out of the cap 25, then the longitudinal axis of the stop fitting is aligned parallel to the axis x so that the fitting 31 can be pushed by a tool pin through the passage 29.

A further embodiment of the system of this invention is shown in FIGS. 6 to 8. A cord 37 with a crimped or swaged fitting 51 is fitted through a cylindrical passage 38 in another connector 50 formed by a mounting element 39 to secure the cord 37 to a plastic plate 41. The plastic plate 51 serves for mounting the liner 13.

Flanks 52a and 52b of the fitting 51 bear on faces 40a and 40b in a pocket 49 formed in the mounting element 39. The pocket 49 receives a portion 53 of a plastic plate 41 formed with a latch nose 42. The latch nose 42 engages in a hole 43 of the mounting element 39 so that the plastic plate 41 is fixed to the mounting element 39. The cylindrical passage 38 is dimensioned as not shown in FIGS. 6 to 8 such that it can be fitted through it when a longitudinal axis z of the fitting 51 is parallel to a longitudinal axis s (FIG. 7) of the passage 38.

Such mounting is done by aligning the longitudinal axis z of the fitting 51 parallel to the longitudinal axis s of the passage 38 and forcing the fitting 51 with a tool through the passage 38. Once the longitudinal axis z is perpendicular to the axis s of the passage 38, the fitting 51 cannot be pulled back out through the passage 38.

In the embodiment of FIGS. 6 to 8 it is possible to secure the plate 51 by stitching, gluing or bonding to the liner 13 and then insert the cord 37, after feeding it through an eye, with its fitting 51 as connector into the passage 38 to lock the assembly together. Then the mounting element 39 with the plate 41 is latched by the nose 42 in the hole 43. This makes subsequent disconnection of the cord 37 from the liner 13 simple.

It is worth noting that although the invention is shown in the drawing as only for tension, the device 10 can also be used to position the cover elements, for example of parts of a liner 13.

1. A device for stretching or positioning at least one roof panel (13), in particular of a motor-vehicle convertible roof, relative to at least one link element with at least one traction element (11a, 11b, 37), in particular a cable, for connection to the link element (29) and/or to a roof panel (13) and that for this purpose at least one end one connector (31, 51) that cooperates with another connector (12a, 12b, 13c, 50) that is directly or indirectly fixed on the roof panel (13) or on the link element (20), characterized in that the one connector (31, 51) and the other connector (12a, 12b, 12c, 50) are releasably connected together.

2. The device according to claim 1, characterized in that the one connector (31, 51) and the other connector (12a, 12b, 12c, 50) are fitted into each other.

3. The device according to claim 1, characterized in that the one connector is an anchor element (31, 51) and the other connector (12a, 12b, 12c, 50) has an abutment (32a 33b, 33c, 40a, 40b).

4. The device according to claim 3, characterized in that the other connector (12a, 12b, 12c, 50) has at least one tunnel- or window-like passage (29, 39) through which extends an end of the traction element (11a, 11b, 37) or the one connector (31, 51).

5. The device according to claim 4, characterized in that the passage has a diameter (B), a length (H) of the one connector (31, 51) being greater than the diameter (B).

6. The device according to claim 4, characterized in that wall faces (33a, 33b, 33c, 40a, 40b) of the other connector (12a, 12b, 12c, 50) turned toward the one connector (31, 51) and adjacent the passage (29, 38) form the abutment.

7. The device according to claim 1, characterized in that the one connector is formed by a stop fitting (31, 51) fixed on the traction element (11a, 11b, 37).

8. The device according to claim 7, characterized in that a longitudinal axis (1) of the stop fitting (31, 51) is generally perpendicular to a longitudinal axis of the traction element (11a, 11b, 37).

9. The device according to claim 1, characterized in that the other connector (12a, 12b, 12c, 50) has at least a first region (25, 26, 27, 39) for securing the one connector (31, 51) and a second region (24, 41) for securing to the roof panel (13) or to the link element (20).

10. The device according to claim 9, characterized in that the second region (24, 41) of the other connector (12a, 12b, 12c) is formed by a plate-shaped element (41) or a bar element (24).

11. The device according to claim 9, characterized in that the first region of the other connector (12a, 12b, 12c) is unitarily formed with the second region (24).

12. The device according to claim 9, characterized in that the other connector (50) is formed of at least two regions, the first region (39) being separable from the second region (41).

13. The device according to claim 12, characterized in that a latch nose (42) is provided on the one region (41) that engages complementarily in a recess (43) of the other region (39).

14. The device according to claim 1, characterized in that at least two other connectors (25, 26, 27) are connected with each other.

15. The device according to claim 1, characterized in that the other connector (12a, 12b, 12c) is provided with a wedge seat (34) for deflecting the traction element (11a, 11b).

16. The device according to claim 15, characterized in that the wedge seat (34) has a V-shaped diverging passage region (35).

17. In combination with a convertible roof element and a link mechanism for moving the element between open and closed positions, a mounting system comprising:
a cord having a pair of opposite ends;
an anchor member on the roof element;
a connector member on the link mechanism, one of the members being attached to one of the cord ends; and
means including a fitting on the other end of the cord and a mount on the other of the members for releasably connecting the other cord end to the other member.

18. The mounting system defined in claim 17 wherein the mount is formed with a throughgoing passage through which the cord extends.

19. The mounting system defined in claim 18 wherein the fitting has a longitudinal dimension greater than a width of the passage and a thickness smaller than the passage width, whereby the fitting can pass longitudinally through the passage.

20. The mounting system defined in claim 19 wherein the mount has end faces at an end of the passage against which the fitting bears.
